(19) United States
(12) Patent Application Publication
(10) Pub. No.: US 2023/0146886 A1
(43) Pub. Date: May 11, 2023

(54) Voice to Message Branded Video Call

(71) Applicant: T-Mobile Innovations LLC, Overland Park, KS (US)

(72) Inventor: Melodie Magdalene Sobrenilla, Sumner, WA (US)

(21) Appl. No.: 17/522,518

(22) Filed: Nov. 9, 2021

(51) Int. Cl. H04L 29/06

(52) U.S. Cl. CPC H04L 65/1089; H04L 65/403

(57) ABSTRACT

Systems and methods for providing interoperable communication during a branded video session via a telecommunication network include a provider device including an in-session interface, a cell site, and session management circuitry communicatively coupled to the cell site and a contact center. The provider device is structured to receive an indication of an interoperable communication during a branded video session, determine a session address responsive to receiving the indication of the interoperable communication, the session address identifying a receiver device to receive session continuity data, generate an interoperable interface, based on the indication of the interoperable communication, switch between a first communication mode and a secondary communication mode during the branded video session, receive, by the interoperable interface, the session continuity data, the session continuity data including in-session message data or in-session video data, and based on the session address, provide the session continuity data during the branded video session.

### SUMMARY

The present disclosure is directed, in part, to providing interoperable communication during a branded video session via a telecommunication network, substantially as shown in and/or described in connection with at least one of the figures, and as set forth more completely in the claims.

In aspects set forth herein, a provider device is connected to a telecommunication network. Typically, the provider device is connected, by the telecommunication network, to a contact center that routes the call to an agent workstation. During a session with an agent, the person talking with the agent may need to exit the conversation to tend to other things. Often times, the person must call the contact center back, repeat the information, and start a new session with a different agent. However, here, a provider device receives an indication of an interoperable communication during a branded video session, switches between a first communication mode and secondary communication mode, and provides session continuity data (e.g., in-session message data) during the branded video session to a receiver device correlated to a contact center which maintains the continuity of the branded video session and permits the person to continue the communication with the same agent.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE SEVERAL VIEWS OF THE DRAWINGS

Illustrative embodiments of the present invention are described in detail below with reference to the attached drawing figures, and wherein:

FIG. 1 depicts an example of a network environment in accordance with one or more embodiments;

FIG. 2 is a diagram of a network environment including a provider device and receiver device in accordance with an example embodiment;

FIG. 3 depicts a flowchart of an exemplary method for providing interoperable communication during a branded video session via a telecommunication network in accordance with an example embodiment; and

FIG. 4 depicts an exemplary computing device suitable for use in implementations of aspects herein.

### DETAILED DESCRIPTION

The subject matter of embodiments of the invention is described with specificity herein to meet statutory requirements. However, the description itself is not intended to limit the scope of this patent. The claimed subject matter might be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described.

In certain aspects, methods are provided for providing interoperable communication during a branded video session via a telecommunication network. An indication of an interoperable communication is received during a branded video session. A session address is determined responsive to receiving the indication of the interoperable communication. The session address identifies a receiver device to receive session continuity data. An interoperable interface is generated. Based on the indication of the interoperable communication, a first communication mode is switched to a secondary communication mode during the branded video session. The session continuity data is received. The session continuity data is provided, based on the session address, during the branded video session.

Advantageously, providing interoperable communication during a branded video session maintains continuous communication during the branded video session.

In one aspect, a method is provided for providing interoperable communication during a branded video session via a telecommunication network. The method includes receiving, via a provider device including an in-session interface and a mode initiator, an indication of an interoperable communication during a branded video session. The method also includes determining a session address responsive to receiving the indication of the interoperable communication, the session address identifying a receiver device to receive session continuity data. The receiver device is communicatively coupled to session management circuitry of a contact center. The method further includes generating an interoperable interface. The method further includes, based on the indication of the interoperable communication, switching between a first communication mode and a secondary communication mode during the branded video session. The method further includes receiving, by the interoperable interface, the session continuity data. The method further includes, based on the session address, providing, by the provider device, the session continuity data during the branded video session.

In another aspect, a computer-readable storage media having computer-executable instructions embodied thereon is provided that, when executed by one or more processors, cause the processors to perform various steps. The processors are caused to receive, via a provider device comprising an in-session interface and a mode initiator, an indication of an interoperable communication during a branded video session. The processors are caused to determine a session address responsive to receiving the indication of the interoperable communication, the session address identifying a receiver device to receive session continuity data, wherein the receiver device is communicatively coupled to session management circuitry of a contact center. The processors are also caused to generate an interoperable interface based on the indication of the interoperable communication. The processors are also caused to, based on the indication of the interoperable communication, switch between an in-session voice mode and an in-session message mode during the branded video session. The processors are caused to receive, by the interoperable interface, the session continuity data, the session continuity data including in-session message data or in-session video data. The processors are also caused to, based on the session address, provide, by the provider device, the session continuity data during the branded video session.

In yet another aspect, a system is provided for providing interoperable communication during a branded video session via a telecommunication network. The system includes a provider device including an in-session interface, a cell site, and session management circuitry communicatively coupled to the cell site and a contact center. The provider device receives an indication of an interoperable communication during a branded video session. The provider device also determines a session address responsive to receiving the indication of the interoperable communication, the session address to identify a receiver device to receive session continuity data. The receiver device is communicatively coupled to session management circuitry. The provider device further generates an interoperable interface. The provider device further provides, based on the indication of the interoperable communication, switches between a first communication mode and a secondary communication mode during the branded video session. The provider device further receives, by the interoperable interface, the session continuity data. The session continuity data includes in-session message data or in-session video data. The provider device further provides, based on the session address, the session continuity data during the branded video session.

Throughout this disclosure, several acronyms and shorthand notations are used to aid the understanding of certain concepts pertaining to the associated system and methods. These acronyms and shorthand notations are intended to help provide an easy methodology of communicating the ideas expressed herein and are not meant to limit the scope of aspects herein.

Embodiments herein may be embodied as, among other things: a method, system, or set of instructions embodied on one or more computer-readable media. Computer-readable media include both volatile and nonvolatile media, removable and non-removable media, non-transitory and/or transitory media, and contemplate media readable by a database, a switch, and various other network devices. Computer-readable media includes media implemented in any way for storing information. Examples of stored information include computer-useable instructions, data structures, program circuitry, and other data representations. Media examples include RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently. Embodiments may take the form of a hardware embodiment, or an embodiment combining software and hardware. Some embodiments may take the form of a computer-program product that includes computer-useable or computer-executable instructions embodied on one or more computer-readable media.

“Computer-readable media” may be any available media and may include volatile and nonvolatile media, as well as removable and non-removable media. By way of example, and not limitation, computer-readable media may include computer storage media and communication media.

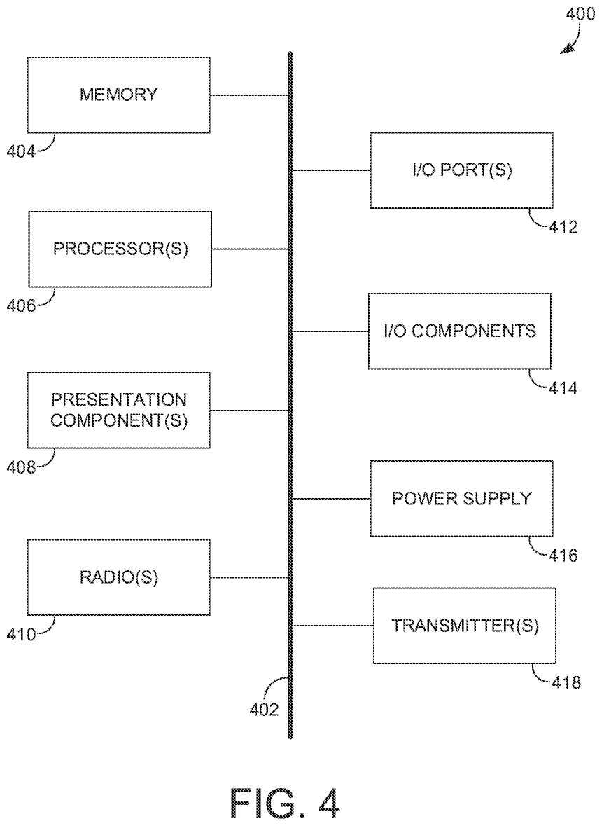

“Computer storage media” may include, without limitation, volatile and nonvolatile media, as well as removable and non-removable media, implemented in any method or technology for storage of information, such as computer-readable instructions, data structures, program circuitry, or other data. In this regard, computer storage media may include, but is not limited to, Random Access Memory (RAM), Read-Only Memory (ROM), Electrically Erasable Programmable Read-Only Memory (EEPROM), flash memory or other memory technology, CD-ROM, digital versatile disks (DVDs) or other optical disk storage, magnetic cassettes, magnetic tape, magnetic disk storage, or other magnetic storage devices, or any other medium which may be used to store the desired information and which may be accessed by the computing device 400 shown in FIG. 4. Computer storage media does not comprise a signal per se.

“Communication media” may include, without limitation, computer-readable instructions, data structures, program circuitry, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above also may be included within the scope of computer-readable media.

The terms “user equipment,” “UE,” “provider device,” “receiver device,” and “user device” are used interchangeably to refer to a device employed by an end-user that communicates using a network. UE generally includes one or more antenna coupled to a radio for exchanging (e.g., transmitting and receiving) transmissions with a nearby base station, via an antenna array of the base station. In embodiments, the UE may take on any variety of devices, such as a personal computer, laptop computer, tablet, netbook, mobile phone, smart phone, personal digital assistant, wearable device, augmented reality device, fitness tracker, or any other device capable of communicating using one or more resources of the network. The UE may include components such as software and hardware, a processor, a memory, a display component, a power supply or power source, a speaker, a touch-input component, a keyboard, and the like. In embodiments, some of the UE discussed herein may include current UE capable of using 5G or 6G and having backward compatibility with prior access technologies, current UE capable of using 5G or 6G and lacking backward compatibility with prior access technologies, and legacy UE that is not capable of using 5G or 6G.

A “network” refers to a network comprised of wireless and wired components that provide wireless communications service coverage to one or more UE. The network may comprise one or more base stations, one or more cell sites (i.e., managed by a base station), one or more cell towers (i.e., having an antenna) associated with each base station or cell site, a gateway, a backhaul server that connects two or more base stations, a database, a power supply, sensors, and other components not discussed herein, in various embodiments.

The terms “base station” and “cell site” may be used interchangeably herein to refer to a defined wireless communications coverage area (i.e., a geographic area) serviced by a base station. It will be understood that one base station may control one cell site or alternatively, one base station may control multiple cell sites. As discussed herein, a base station is deployed in the network to control and facilitate, via one or more antenna arrays, the broadcast, transmission, synchronization, and receipt of one or more wireless signals in order to communicate with, verify, authenticate, and provide wireless communications service coverage to one or more UE that request to join and/or are connected to a network.

An “access point” may refer to hardware, software, devices, or other components at a base station, cell site, and/or cell tower having an antenna, an antenna array, a radio, a transceiver, and/or a controller. Generally, an access point may communicate directly with user equipment according to one or more access technologies (e.g., 3G, 4G, LTE, 5G, mMIMO) as discussed hereinafter.

The terms “radio,” “controller,” “antenna,” and “antenna array” are used interchangeably to refer to one or more software and hardware components that facilitate sending and receiving wireless radio-frequency signals, for example, based on instructions from a base station. A radio may be used to initiate and generate information that is then sent out through the antenna array, for example, where the radio and antenna array may be connected by one or more physical paths. Generally an antenna array comprises a plurality of individual antenna elements. The antennas discussed herein may be dipole antennas, having a length, for example, of ¼, ½, 1, or 1½ wavelength. The antennas may be monopole, loop, parabolic, traveling-wave, aperture, yagi-uda, conical spiral, helical, conical, radomes, horn, and/or apertures, or any combination thereof. The antennas may be capable of sending and receiving transmission via FD-MIMO, Massive MIMO, 3G, 4G, 5G, and/or 802.11 protocols and techniques.

Additionally, it will be understood that terms such as “first,” “second,” and “third” are used herein for the purposes of clarity in distinguishing between elements or features, but the terms are not used herein to import, imply, or otherwise limit the relevance, importance, quantity, technological functions, sequence, order, and/or operations of any element or feature unless specifically and explicitly stated as such.

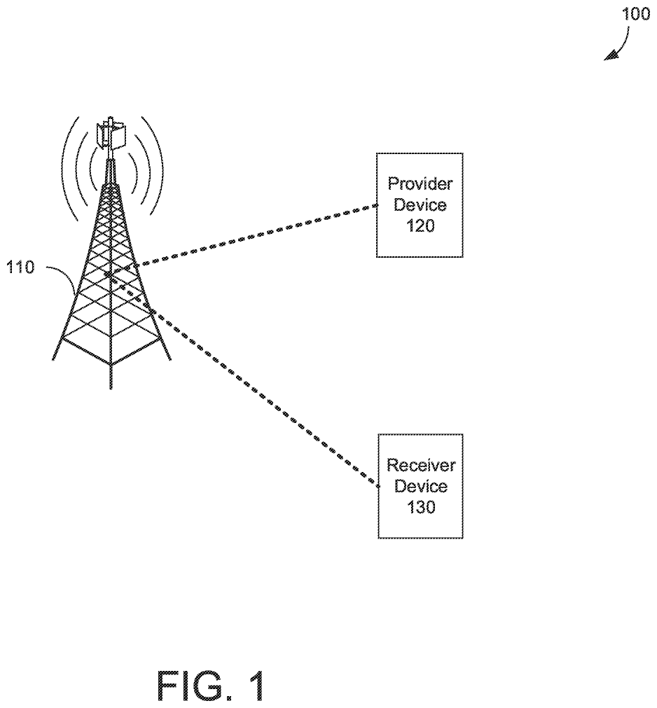

FIG. 1 illustrates an example of a network environment 100 suitable for use in implementing embodiments of the present disclosure. The network environment 100 is but one example of a suitable network environment and is not intended to suggest any limitation as to the scope of use or functionality of the disclosure. Neither should the network environment 100 be interpreted as having any dependency or requirement relating to any one or combination of components illustrated.

The network environment 100 provides service to one or more user devices 120 and 130. In some embodiments, the network environment 100 may include a telecom network (e.g., a telecommunication network such as, but not limited to, a wireless telecommunication network), or portion thereof. The network environment 100 may include one or more devices and components, such as base stations, servers, switches, relays, amplifiers, databases, nodes, etc. which are not shown so as to not confuse other aspects of the present disclosure. Those devices and components may provide connectivity in a variety of implementations. In addition the network environment 100 may be utilized in a variety of manners, such as a single network, multiple networks, or as a network of networks, but, ultimately, is shown as simplified as possible to avoid the risk of confusing other aspects of the present disclosure.

The telecom network included in the network environment 100 may include or otherwise may be accessible through a cell site (e.g., the cell site 110). The cell site may include one or more antennas, base transmitter stations, radios, transmitter/receivers, digital signal processors, control electronics, GPS equipment, power cabinets or power supply, base stations, charging stations, etc. such that the cell site may provide a communication link between one or more user devices (e.g., one or more provider devices and/or receiver devices such as the user devices 120 and 130) and other components, systems, equipment, and/or devices of the network environment 100. The base station and/or a computing device (e.g., whether local or remote) associated with the base station may manage or otherwise control the operations of components of the cell site.

In some embodiments, the cell site may be operable in a non-stand alone (NSA) mode. In the non-stand alone mode the network environment 100 may take the form of, for example, an E-UTRAN New Radio-Dual Connectivity (EN-DC) network. In an EN-DC network, a provider device and/or a receiver device may connect to or otherwise access a 4G, LTE, 5G, or any other suitable network simultaneously. In the stand alone mode, the telecom network may take the form of a 5G, 6G, or any other suitable network.

In some embodiments, the network environment 100 may include one or more nodes communicatively coupled to one or more provider devices and one or more receiver devices such that the node(s) may transmit to and receive requests and/or data from the provider device(s) and/or the receiver device(s). The one or more nodes may include a Next Generation Node B (e.g., gNodeB or gNB) or any other suitable node. The one or more nodes may correspond to one or more frequency bands within which the provider device(s) and/or the receiver device(s) may connect to the network environment such as, but not limited to, a telecommunication network or a portion thereof.

In some embodiments, the node(s) may be included within the cell site (e.g., the cell site 110), external to the cell site, or otherwise communicatively coupled to the cell site. The node(s) may allocate radio frequency, or a portion thereof, to user device(s).

In some embodiments, the provider device(s) and/or the receiver device(s) may take the form of a wireless or mobile device capable of communication via the network environment 100. For example, the provider device 120 may take the form of a mobile device capable of communication via a telecom network such as, but not limited to, a wireless telecommunication network. In this regard, the provider device(s) and/or the receiver device(s) may be any computing device that communicates by way of a network, for example, a 4G, LTE, WiMAX, Wi-Fi, 5G, 6G, or any other type of network.

In some embodiments, the network environment 100 may connect subscribers (e.g., current subscribers and/or potential subscribers) to a service provider or a plurality of service providers. Alternatively or additionally, the network environment 100 may be associated with a specific telecommunication provider or a plurality of telecommunication providers that provide services (e.g. 5G, 6G, voice, location, data, etc.) to one or more user devices. For example, the provider device 120 and/or the receiver device 130 may be subscribers to a telecommunication service provider, in which the devices are registered or subscribed to receive voice and data services (e.g., receive content that may be streamed, downloaded, etc.) over the network environment 100. The network environment 100 may include any communication network providing voice and/or data service(s), such as, for example, a Wi-Fi network, 4G network (LTE, WiMAX, HSDPA), 5G network, or 6G network.

Having described the network environment 100 and components operating therein, it will be understood by those of ordinary skill in the art that the network environment 100 is but one example of a suitable network and is not intended to limit the scope of use or functionality of aspects described herein. Similarly, the network environment 100 should not be interpreted as imputing any dependency and/or any requirements with regard to each component and combination(s) of components illustrated in FIG. 1. It will be appreciated by those of ordinary skill in the art that the number, interactions, and physical location of components illustrated in FIG. 1 are examples, as other methods, hardware, software, components, and devices for establishing one or more communication links between the various components may be utilized in implementations of the present invention. It will be understood to those of ordinary skill in the art that the components may be connected in various manners, hardwired or wireless, and may use intermediary components that have been omitted or not included in FIG. 1 for simplicity's sake. As such, the absence of components from FIG. 1 should not be interpreted as limiting the present invention to exclude additional components and combination(s) of components. Moreover, though components may be represented as singular components or may be represented in a particular quantity in FIG. 1, it will be appreciated that some aspects may include a plurality of devices and/or components such that FIG. 1 should not be considered as limiting the quantity of any device and/or component.

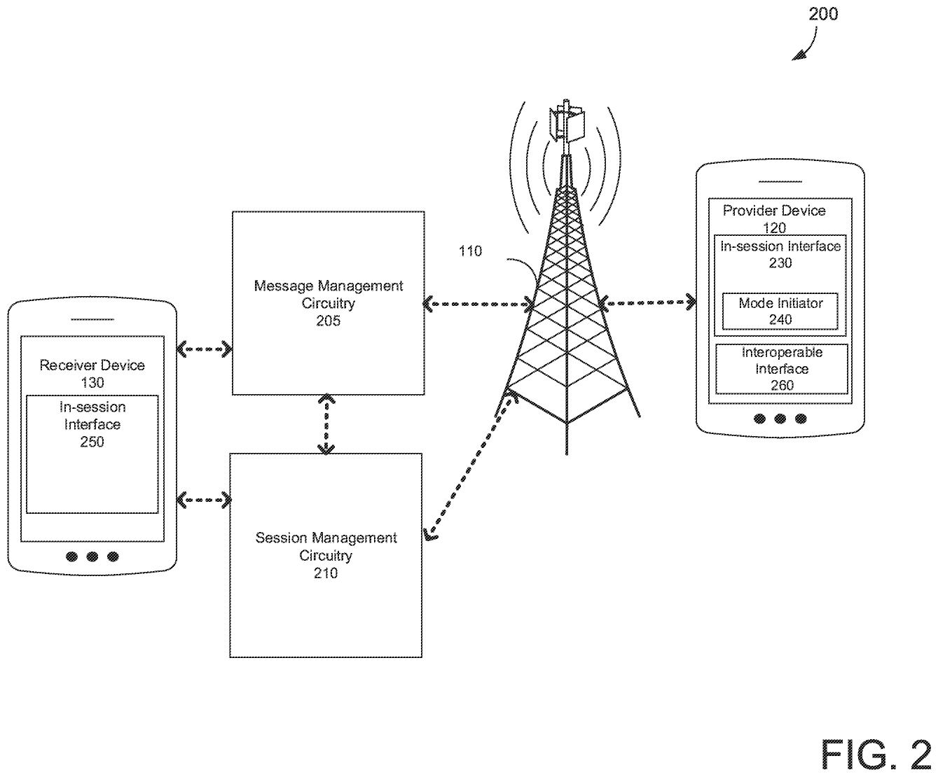

FIG. 2 is a diagram of the network environment 200 (e.g., a telecommunication environment such as, but not limited to, a wireless telecommunication environment) according to an example embodiment. In the present embodiment, the network environment 200 includes the cell site 110, message management circuitry 205, session management circuitry 210, provider device 120, and receiver device 130. Although some of the components in the network environment 200 are depicted as single components (e.g., a single provider device, receiver device, message management circuitry, cell site, etc.), in some embodiments, the network environment 200 may include a plurality of such components.

In some embodiments, the provider device (e.g., the provider device 120) may receive an indication of an interoperable communication during a branded video session (e.g., a video session with an agent of a verified vendor). As used herein, the term “interoperable communication” may be used to refer to communication between video communication and message communication. The provider device may include an in-session interface (e.g., the in-session interface 230). The in-session interface may, in some examples, include one or more in-call options. For example, the in-session interface may include a keypad, call menu, and/or any other feature that may be utilized during a branded video session. In some embodiments, the in-session interface may include a mode initiator (e.g., the mode initiator 240). As used herein, the term “mode initiator” may be used to refer to a text button, message box, video button, call button, and/or any component that initiates the receipt of input. For example, the mode initiator (e.g., a text button) may initiate the receipt of session continuity data (e.g., in-session message data that may be sent between user devices during the branded video session). Alternatively or additionally, the mode initiator (e.g., a video button) may initiate the receipt of session continuity data (e.g., in-session video data that may be transmitted between user devices during the branded video session). A user of a provider device may select, press, tap and/or provide a voice command that awakens (e.g., activates) the mode initiator during the branded video session to initiate the receipt of session continuity data. Providing a user with a mode initiator allows the user to continue communication with the same agent during a branded video session.

In some embodiments, the provider device may determine a session address. The session address may be determined responsive to the indication of the interoperable communication received. The session address may identify a receiver device (e.g., the receiver device 130) to receive the session continuity data. The session address may include one or more numeric characters and/or alphabet characters. For example, the session address may include at least one of a phone number or an extension. The session address may identify a device (e.g., a receiver device, provider device, etc.) to receive the session continuity data.

In some examples, the provider device may determine the session address responsive to receiving the indication of the interoperable communication. In some embodiments, the provider device may include circuitry that looks up, via one or more databases, the session address.

The provider device (e.g., the provider device 120) may generate an interoperable interface (e.g., the interoperable interface 260). The interoperable interface generated may include the session address and/or any other identifier associated with the device (e.g., the receiver device 130) to receive the session continuity data. The interoperable interface may include a mode initiator. For example, the interoperable interface may include the mode initiator such as, but not limited to, a text button, message box, video button, or call button, or a combination thereof. Based on the indication of the interoperable communication received, the provider device may switch between a first communication mode and a secondary communication mode during the branded video session. The first communication mode may take the form of an in-session voice mode and the secondary communication mode may take the form of an in-session message mode. In some examples, the first communication mode may take the form of an in-session message mode and the secondary communication mode may take the form of an in-session voice mode. In this regard, the provider device may perform a handoff, via one or more APIs (Application Programming Interface(s)), between the first communication mode and the secondary communication mode.

The provider device may receive, via the inter-operable interface, the session continuity data during the branded video session. The session continuity data may include in-session message data or in-session video data. In this regard, the interoperable interface may receive, via a message box, one or characters (e.g., numeric characters/alphabet characters) during the branded video session. In other examples, the interoperable interface may receive in-session video data (e.g., video signals and/or audio signals).

The provider device may provide the session continuity data during the branded video session. The session continuity data may be provided, based on the session address. In some examples, the session continuity data (e.g., the in-session message data) may be transmitted or otherwise received by the message management circuitry 205. The session continuity data may be provided, in some examples, by the message management circuitry 205 to the session management circuitry 210 communicatively coupled to one or more receiver device(s). In some embodiments, the session management circuitry 210 may be included within a contact center system(s), external to the contact center system(s), or otherwise communicatively coupled to contact center system(s).

In some examples, the session continuity data (e.g., in-session video data) may be provided to the session management circuitry 210 and/or the receiver device 130. The in-session video data may be converted to digital bits. The digital bits may be compressed/coded and placed into packets. The packets may be transmitted, via the network 200, to the receiver device 130 and/or the session management circuitry 210 in real-time or near real-time. The packets may be decompressed/decoded and converted into video signals and/or audio signals.

In some embodiments, the message management circuitry 205 may provide (e.g., may transmit, forward, route, etc.) the session continuity data to the receiver device communicatively coupled to the session management circuitry 210. If the receiver device is in an inactive state (e.g., powered off), the message management circuitry 205 may store the session continuity data (e.g., in-session message data). In further embodiments, if the receiver device moves from the inactive state to an active state (e.g., powered on), the message management circuitry 205 may provide the session continuity data (e.g., in-session message data) to the receiver device communicatively coupled to the session management circuitry 210. In some embodiments, the session management circuitry may include one or more user interfaces (e.g., interoperable interfaces that may receive, output, display, and/or provide session continuity data). The user interface(s) may be communicatively coupled to and/or operable via one or more APIs. The APIs may provide or otherwise transmit the session continuity data between the user interface(s) and/or the session management circuitry 210.

Alternatively or additionally, the user interface(s) may receive the session address (e.g., phone number) of the provider device during the branded video session. In some examples, the branded video session may be initiated by the transmission of an invitation to join the branded video session to the message management circuitry 205. The management circuitry 205 may provide or otherwise transmit the invitation to join the branded video session to the provider device 120. The provider device may accept the invitation to join the branded video session by receiving an indication of the interoperable communication as described herein.

The session continuity data may be output by a second in-session interface (e.g., the in-session interface 250) of the receiver device (e.g., the receiver device 130 such as, but not limited to, a laptop, desktop, mobile device, wearable, wireless device, etc.), mobile application, contact center application, dashboard, and/or any other suitable output device, system, and/or component. Advantageously, providing interoperable communication during a branded video session via a telecommunication network ensures the continuity of communication between the caller and an agent of a vendor during a branded video session.

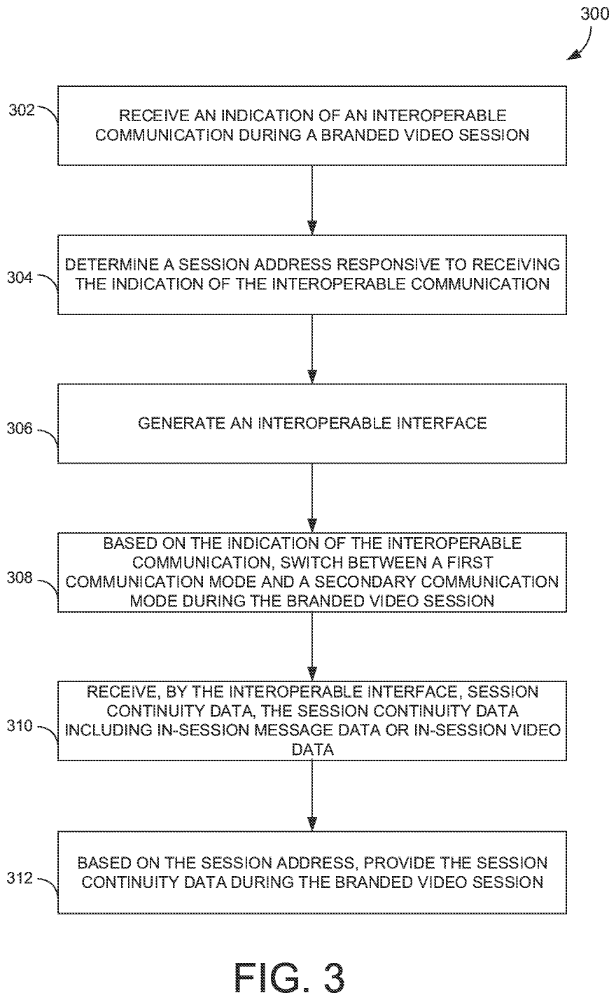

FIG. 3 depicts a flow diagram of an exemplary method 300 for providing interoperable communication during a branded video session via a telecommunication network, in accordance with implementations of the present disclosure. Initially at block 302 an indication of an interoperable communication (e.g., communication between video communication and message communication) is received by the provider device during a branded video session. The provider device may include an in-session interface. The in-session interface may, in some examples, include one or more in-call options (e.g., a keypad, call menu, mode initiator, etc.). The mode initiator (e.g., a text button, video button, etc.) may initiate the receipt of session continuity data (e.g., in-session message data that can be sent during the branded video session or in-session video data that may be transmitted during the branded video session).

At block 304, a session address is determined responsive to receiving the indication of the interoperable communication. The session address (e.g., one or more characters and/or digits) may identify a device (e.g., a receiver device, provider device, etc.) to receive session continuity data. The session address may include, for example, at least one of a phone number or an extension.

In some embodiments, an interoperable interface is generated at block 306. The interoperable interface generated may include the session address and/or any other identifier associated with the device to receive the session continuity data. At block 308, based on the indication of the interoperable communication (e.g., the selection of a text button or a video button) received, a first communication mode (e.g., in-session voice mode) is switched to a secondary communication mode (e.g., in-session message mode) during the branded video session. The provider device may perform a handoff between the first communication mode and the secondary communication mode.

The session continuity data is received during the branded video session at block 310. In some examples, the interoperable interface may receive, via a message box, one or characters during the branded video session. Alternatively or additionally, the interoperable interface may receive in-session video data (e.g., video signals and/or audio signals).

At block 312, the session continuity data (e.g., in-session message data) is provided during the branded video session. The session continuity data may be provided (e.g., transmitted), based on the session address. The session continuity data may be provided to the message management circuitry 205, the session management circuitry 210, and/or the receiver device 130. The session continuity data may be output by an in-session interface of the receiver device, contact center application, dashboard, and/or any other suitable output device, system, and/or component.

Referring to FIG. 4, a block diagram of an example of a computing device 400 suitable for use in implementations of the technology described herein is provided. In particular, the exemplary computer environment is shown and designated generally as computing device 400. Computing device 400 is but one example of a suitable computing environment and is not intended to suggest any limitation as to the scope of use or functionality of the invention. Neither should computing device 400 be interpreted as having any dependency or requirement relating to any one or combination of components illustrated. In aspects, the computing device 400 may be a base station. In another embodiment, the computing device 400 may be UE capable of two-way wireless communications with an access point. Some non-limiting examples of the computing device 400 include a base station, a controller at a base station, a backhaul server, a personal computer, a cell phone, current UE, legacy UE, a tablet, a pager, a personal electronic device, a wearable electronic device, an activity tracker, a laptop, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

As shown in FIG. 4, computing device 400 includes a bus 402 that directly or indirectly couples various components together. The bus 402 may directly or indirectly one or more of memory 404, processor(s) 406, presentation component(s) 408 (if applicable), radio(s) 410, input/output (I/O) port(s) 412, input/output (I/O) component(s) 414, power supply 416, and/or transmitter(s) 418. Although the components of FIG. 4 are shown with lines for the sake of clarity, in reality, delineating various components is not so clear, and metaphorically, the lines would more accurately be grey and fuzzy. For example, one may consider a presentation component(s) 408 such as a display device to be one of I/O components 414. Also, the processor(s) 406 may include memory 404, in another example. The present disclosure hereof recognizes that such is the nature of the art, and reiterates that FIG. 4 is merely illustrative of an example of a computing device 400 that may be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 404 may take the form of memory components described herein. Thus, further elaboration will not be provided here, but it should be noted that memory 404 may include any type of tangible medium that is capable of storing information, such as a database or data store. A database or data store may be any collection of records, files, or information encoded as electronic data and stored in memory 404, for example. In one embodiment, memory 404 may include a set of embodied computer-readable and executable instructions that, when executed, facilitate various functions or elements disclosed herein. These embodied instructions will variously be referred to as “instructions” or an “application” for short.

Processor(s) 406 may be multiple processors that receive instructions and process them accordingly. Presentation component(s) 408, if available, may include a display device, an audio device such as a speaker, and/or other components that may present information through visual (e.g., a display, a screen, a lamp (LED), a graphical user interface (GUI), and/or even lighted keyboards), auditory, and/or other tactile or sensory cues.

Radio(s) 410 represents one or more radios that facilitate communication with a wireless telecommunication network. For example, radio(s) 410 may be connected to one or more antenna elements through a physical path. Illustrative wireless telecommunications technologies include CDMA, GPRS, TDMA, GSM, and the like. Radio(s) 410 might additionally or alternatively facilitate other types of wireless communications including Wi-Fi, WiMAX, 3G, 4G, LTE, mMIMO, 5G, 6G, NR, VoLTE, and/or other VoIP communications. As can be appreciated, in various embodiments, radio(s) 410 may be configured to concurrently support multiple technologies, as previously discussed herein. As such, each of many radio(s) 410 may be used to separately control portions of an antenna array, for example, where at least one portion utilizes a distinct technology relative to another portion in the same antenna array or at the same base station or cell site. A wireless telecommunication network might include an array of devices, which are not shown so as to not obscure more relevant aspects of the invention. Components such as a base station, a communications tower, or even access points (as well as other components) can provide wireless connectivity in some embodiments.

The input/output (I/O) ports 412 may take a variety of forms. Exemplary I/O ports 412 may include a USB jack, a stereo jack, an infrared port, a firewire port, other proprietary communications ports, and the like. Input/output (I/O) components 414 may comprise keyboards, microphones, speakers, touchscreens, and/or any other item usable to directly or indirectly input data into the computing device 400.

Power supply 416 may include batteries, fuel cells, and/or any other component that may act as a power source to supply power to the computing device 400 or to other network components, including through one or more electrical connections or couplings. Power supply 416 may be configured to selectively supply power to different components independently and/or concurrently.

Finally, regarding FIGS. 1 through 4, it will be understood by those of ordinary skill in the art that the environment(s), system(s), and/or methods(s) depicted are not intended to limit the scope of use or functionality of the present embodiments. Similarly, the environment(s), system(s), and/or methods(s) should not be interpreted as imputing any dependency and/or any requirements with regard to each component, each step, and combination(s) of components or step(s) illustrated therein. It will be appreciated by those having ordinary skill in the art that the connections illustrated the figures are contemplated to potentially include methods, hardware, software, and/or other devices for establishing a communications link between the components, devices, systems, and/or entities, as may be utilized in implementation of the present embodiments. As such, the absence of component(s) and/or steps(s) from the figures should be not be interpreted as limiting the present embodiments to exclude additional component(s) and/or combination(s) of components. Moreover, though devices and components in the figures may be represented as singular devices and/or components, it will be appreciated that some embodiments can include a plurality of devices and/or components such that the figures should not be considered as limiting the number of devices and/or components.

It is noted that aspects of the present invention are described herein with reference to block diagrams and flowchart illustrations. However, it should be understood that each block of the block diagrams and/or flowchart illustrations may be implemented in the form of a computer program product, an entirely hardware embodiment, a combination of hardware and computer program products, and/or apparatus, systems, computing devices/entities, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

Additionally, as should be appreciated, various embodiments of the present disclosure described herein can also be implemented as methods, apparatus, systems, computing devices/entities, computing entities, and/or the like. As such, embodiments of the present disclosure can take the form of an apparatus, system, computing device, computing entity, and/or the like executing instructions stored on a computer-readable storage medium to perform certain steps or operations. However, embodiments of the present disclosure can also take the form of an entirely hardware embodiment performing certain steps or operations.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned may be completed without departing from the scope of the claims below. Certain features and sub-combinations are of utility and may be employed without reference to other features and sub-combinations and are contemplated within the scope of the claims.

1. A method for providing interoperable communication during a branded video session via a telecommunication network, the method comprising:
receiving, via a provider device comprising an in-session interface and a mode initiator, an indication of an interoperable communication during a branded video session, wherein the mode initiator is structured for activation in response to a voice command;
determining a session address responsive to receiving the indication of the interoperable communication, the session address identifying a receiver device to receive session continuity data, wherein the receiver device is communicatively coupled to session management circuitry of a contact center;
generating an interoperable interface;
based on the indication of the interoperable communication, switching between a first communication mode and a secondary communication mode during the branded video session;
receiving, by the interoperable interface, the session continuity data, the session continuity data comprising in-session message data or in-session video data; and
based on the session address, providing, by the provider device, the session continuity data during the branded video session.

2. The method of claim 1, wherein the first communication mode comprises an in-session voice mode, and wherein the secondary communication mode comprises an in-session message mode.

3. The method of claim 1, wherein the first communication mode comprises an in-session message mode, and wherein the secondary communication mode comprises an in-session voice mode.

4. The method of claim 1, wherein the in-session interface comprises a keypad.

5. The method of claim 1, wherein the in-session interface comprises one or more in-call options.

6. The method of claim 1, wherein the mode initiator comprises at least one of a text button, message box, video button, or call button.

7. The method of claim 1, wherein the session address comprises at least one of a phone number or an extension.

8. The method of claim 1, wherein the session address comprises at least one of a numeric character or alphabet character.

9. The method of claim 1, wherein the provider device is structured to provide the session continuity data to at least one of message management circuitry or the session management circuitry.

10. The method of claim 8, wherein at least one of the provider device or the receiver device is communicatively coupled to at least one of a 4G network, E-UTRAN New Radio-Dual Connectivity (EN-DC) network, 5G network, 6G network, or Wi-Fi network.

11. Computer-readable storage media having computer-executable instructions embodied thereon that, when executed by one or more processors, cause the one or more processors to:
receive, via a provider device comprising an in-session interface and a mode initiator, an indication of an interoperable communication during a branded video session, wherein the mode initiator is structured for activation in response to a voice command;
determine a session address responsive to receiving the indication of the interoperable communication, the session address identifying a receiver device to receive session continuity data, wherein the receiver device is communicatively coupled to session management circuitry of a contact center;
generate an interoperable interface based on the indication of the interoperable communication;
based on the indication of the interoperable communication, switch between an in-session voice mode and an in-session message mode during the branded video session;
receive, by the interoperable interface, the session continuity data, the session continuity data comprising in-session message data or in-session video data; and
based on the session address, provide, by the provider device, the session continuity data during the branded video session.

12. The computer-readable storage media of claim 11, wherein the in-session interface comprises a keypad.

13. The computer-readable storage media of claim 11, wherein the in-session interface comprises one or more in-call options.

14. The computer-readable storage media of claim 11, wherein the mode initiator comprises at least one of a text button, message box, video button, or call button.

15. The computer-readable storage media of claim 11, wherein the provider device is structured to provide the session continuity data to at least one of message management circuitry or the session management circuitry.

16. A system for providing interoperable communication during a branded video session via a telecommunication network, the system comprising:
a provider device comprising an in-session interface and a mode initiator;
a cell site; and
session management circuitry communicatively coupled to the cell site and a contact center, the provider device structured to:
receive an indication of an interoperable communication during a branded video session, wherein the mode initiator is structured for activation in response to a voice command;
determine a session address responsive to receiving the indication of the interoperable communication, the session address identifying a receiver device to receive session continuity data, wherein the receiver device is communicatively coupled to the session management circuitry of the contact center;
generate an interoperable interface;
based on the indication of the interoperable communication, switch between a first communication mode and a secondary communication mode during the branded video session;
receive, by the interoperable interface, the session continuity data, the session continuity data comprising in-session message data or in-session video data; and
based on the session address, provide the session continuity data during the branded video session.

17. The system of claim 16, wherein the first communication mode comprises an in-session voice mode, and wherein the secondary communication mode comprises an in-session message mode.

18. The system of claim 16, wherein the first communication mode comprises an in-session message mode, and wherein the secondary communication mode comprises an in-session voice mode.

19. The system of claim 16, wherein the mode initiator comprises at least one of a text button, message box, video button, or call button.

20. The system of claim 16, wherein the session address comprises at least one of a phone number or an extension.
